(19) United States
(12) Patent Application Publication
(10) Pub. No.: US 2026/0316689 A1
(43) Pub. Date: Oct. 15, 2026

(54) Fastening Device for Fastening a Component to a Supporting Component in or on a Vehicle

(71) Applicant: Illinois Tool Works Inc., Glenview, IL (US)

(72) Inventors: Melanie Sindel, Nürnberg (DE); Maria Deininiger, Uffenheim (DE); Markus Hüttinger, Ochsenfurt (DE); Manuela Ohr, Mulfingen (DE)

(21) Appl. No.: 19/551,821

(22) Filed: Feb. 27, 2026

(30) Foreign Application Priority Data
Apr. 15, 2025 (DE) 10 2025 114 759.0
Sep. 4, 2025 (DE) 10 2025 135 475.8
Dec. 15, 2025 (DE) 10 2025 152 804.7

(51) Int. Cl. B60R 11/00

(52) U.S. Cl. CPC B60R 11/00; B60R 2011/0059; B60R 2011/0061

(57) ABSTRACT

A fastening apparatus (1) for fastening a component (50) to a carrier component (51) in or on a vehicle. The fastening apparatus (1) includes an anchoring component or a latching component (2) with an anchoring or latching area (3), which is configured for mounting on the carrier component (51), and a holding area (4) opposite the anchoring or latching area (3), to which the component (50) to be attached to the carrier component (51) is connected or connectable. The fastening apparatus (1) further includes a verification device (5), which is configured to confirm correct mounting of the anchoring component or latching component (2) on the carrier component (51) in or at the holding area (4) of the anchoring component or latching component (2), in particular via at least one optically detectable indicator (6).

### RELATED APPLICATIONS

The present application claims the benefit of German Patent Application No. 10 2025 114 759.0, filed Apr. 15, 2025, titled “Fixing Device for Fixing a Component to a Supporting Component in or on a Vehicle;” German Patent Application No. 10 2025 135 475.8, filed Sep. 4, 2025, titled “Fastening Device for Fastening a Component to a Supporting Component in or on a Vehicle;” and German Patent Application No. 10 2025 152 804.7, filed Dec. 15, 2025, titled “Fastening Device for Fastening a Component to a Supporting Component in or on a Vehicle,” the contents of which are hereby incorporated by reference.

### BACKGROUND

Automotive components require fastening techniques that are easy to manufacture and mount. In addition, the fastening techniques are primarily intended to be reliable and efficient. In some cases, objects or components need to be fastened to the vehicle to prevent movement and/or displacement during operation, which can result in damage or kinking of the fastened component. This applies, for example, to pipes, hoses, wires and cable harnesses. These components are often attached to a carrier component in or on a vehicle using a corresponding fastening apparatus.

If a fastening apparatus is incorrectly mounted, i.e., in particular, not fully inserted into the mounting aperture of the carrier component, the fastening apparatus may disengage and/or the component to be fastened may become damaged or disengaged. Likewise, an object that is not correctly attached to a fastening apparatus may disengage from the fastening apparatus.

Therefore, it is desirable to provide an installation or mounting indicator to ensure proper installation or mounting of the fastening apparatus with respect to the carrier component during mounting.

### SUMMARY

The present disclosure relates generally to a fastening apparatus, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates schematically and in a partial sectional view, a first exemplary embodiment of the fastening apparatus according to the disclosure, wherein the fastening apparatus is in its delivered state, and the sliding body of the verification device is in its delivered position.

FIG. 2 illustrates schematically and in an isometric sectional view, the exemplary embodiment of the fastening apparatus according to the disclosure of FIG. 1.

FIG. 3 illustrates schematically and in an isometric view, the first exemplary embodiment of the fastening apparatus according to the disclosure, wherein the fastening apparatus is now in its mounting state.

FIG. 4 illustrates schematically; a fastening apparatus mounted on a carrier component in accordance with a second exemplary embodiment of the disclosure.

FIG. 5 illustrates schematically and in a partial sectional isometric view, the second exemplary embodiment of the fastening apparatus according to the disclosure in an intermediate state between the delivery state of the fastening apparatus and the mounting state fastening apparatus.

FIG. 6 illustrates schematically and in a partial sectional isometric view, the second exemplary embodiment of the fastening apparatus according to the disclosure in its mounting state.

FIG. 7 illustrates schematically and in an isometric top view, the second exemplary embodiment of the fastening apparatus according to the disclosure in its mounted state.

FIG. 8 illustrates schematically and in a top view, the second exemplary embodiment of the fastening apparatus according to the disclosure of FIG. 7, but this time in its mounted state.

FIG. 9 illustrates schematically and in an isometric sectional view, a third exemplary embodiment of the fastening apparatus according to the disclosure.

FIG. 10 illustrates schematically and in an isometric view, the third exemplary embodiment of the fastening apparatus according to the disclosure.

FIG. 11 illustrates schematically and in an isometric view, an isometric side view of the third exemplary embodiment of the fastening apparatus according to the disclosure.

FIG. 12 illustrates schematically and in an isometric side view, the third exemplary embodiment of the fastening apparatus according to the disclosure in its mounted state.

FIG. 13 illustrates schematically and in an isometric sectional view, the third exemplary embodiment of the fastening apparatus according to the disclosure in the mounted state.

FIG. 14 illustrates schematically and in a top view, the third exemplary embodiment of the fastening apparatus according to the disclosure in its mounted state.

FIG. 15 illustrates schematically and in a top view, the third exemplary embodiment of the fastening apparatus according to the disclosure in its unmounted state.

FIG. 16 illustrates schematically and in an isometric sectional view, a fourth exemplary embodiment of the fastening apparatus according to the disclosure.

FIG. 17 illustrates schematically and in an isometric view, the fourth exemplary embodiment of the fastening apparatus according to the disclosure.

FIG. 18 illustrates schematically and in an isometric view, an isometric side view of the fourth exemplary embodiment of the fastening apparatus according to the disclosure.

FIG. 19 illustrates schematically and in an isometric side view, the fourth exemplary embodiment of the fastening apparatus according to the disclosure in its mounted state.

FIG. 20 illustrates schematically and in an isometric sectional view, the fourth exemplary embodiment of the fastening apparatus according to the disclosure in its mounted state.

FIG. 21 illustrates schematically and in a top view, the fourth exemplary embodiment of the fastening apparatus according to the disclosure in its mounted state.

FIG. 22 illustrates schematically and in a top view, the fourth exemplary embodiment of the fastening apparatus according to the disclosure in its unmounted state.

FIG. 23 illustrates schematically and in an isometric sectional view, a fifth exemplary embodiment of the fastening apparatus according to the disclosure.

FIG. 24 illustrates schematically and in an isometric view, the fifth exemplary embodiment of the fastening apparatus according to the disclosure.

FIG. 25 illustrates schematically and in an isometric view, an isometric side view of the fifth exemplary embodiment of the fastening apparatus according to the disclosure.

FIG. 26 illustrates schematically and in an isometric side view, the fifth exemplary embodiment of the fastening apparatus according to the disclosure in its mounted state.

FIG. 27 illustrates schematically and in an isometric sectional view, the fifth exemplary embodiment of the fastening apparatus according to the disclosure in its mounted state.

FIG. 28 illustrates schematically and in a top view, the fifth exemplary embodiment of the fastening apparatus according to the disclosure in its mounted state.

FIG. 29 illustrates schematically and in a top view, the fifth exemplary embodiment of the fastening apparatus according to the disclosure in its unmounted state.

FIG. 30 illustrates schematically and in an isometric sectional view, a sixth exemplary embodiment of the fastening apparatus according to the disclosure.

FIG. 31 illustrates schematically and in an isometric view, the sixth exemplary embodiment of the fastening apparatus according to the disclosure.

FIG. 32 illustrates schematically and in an isometric view, the sixth exemplary embodiment of the fastening apparatus according to the disclosure.

FIG. 33 illustrates schematically and in an isometric view, the sixth exemplary embodiment of the fastening apparatus according to the disclosure in its mounted state.

FIG. 34 illustrates schematically and in an isometric sectional view, the sixth exemplary embodiment of the fastening apparatus according to the disclosure in its mounted state.

FIG. 35 illustrates schematically and in a top view, the sixth exemplary embodiment of the fastening apparatus according to the disclosure in its mounted state.

FIG. 36 illustrates schematically and in a top view, the sixth exemplary embodiment of the fastening apparatus according to the disclosure in its unmounted state.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered. It will be understood that directional references (e.g., upper, lower, upwardly, downwardly) are used for convenience with respect to the orientation shown in the figures and are not intended to limit the scope of the disclosure.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. Terms such as “can,” “may,” and “in certain embodiments” are used to reflect that variations are contemplated. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates generally to a fastening apparatus for fastening a component to a carrier component in or on a vehicle.

According to embodiments of the disclosure, this relates in particular to a fastening apparatus for a cable, for a cable harness or for a power bus in a vehicle, in particular in an e-vehicle or in a hybrid vehicle. However, the disclosure is not limited to this field of application and relates generally to fastening apparatuses for fastening in particular automotive components.

Accordingly, the disclosure relates in particular to a fastening apparatus for fastening a component to a carrier component in or on a vehicle.

The fastening apparatus comprises an anchoring component or a latching component with an anchoring or latching area, which is configured for mounting on the carrier component, and a holding area opposite the anchoring or latching area, to which the component to be attached to the carrier component is connected or connectable.

Moreover, the fastening apparatus comprises a verification device, which is configured to confirm correct mounting of the anchoring component or latching component on the carrier component in or at the holding area of the anchoring component or latching component, in particular via at least one optically detectable indicator.

In particular, the fastening apparatus according to the disclosure provides that the anchoring or latching area of the anchoring component or latching component is at least partially or in regions designed as a plug-in part and configured to be inserted into a mounting aperture provided in the carrier component for mounting of the fastening apparatus on the carrier component and to form a particularly frictional and/or form-fitting connection with the carrier component.

In this context, it is provided that the verification device is configured such that, upon insertion of the anchoring or latching area of the anchoring component or latching component into the mounting aperture provided in the carrier component, the verification device is converted or convertible from an initial delivery state to a mounting state, wherein, in the mounting state of the verification device, at least one indicator of the verification device is or becomes optically detectable in or at the holding area of the anchoring component or latching component.

According to further development of the fastening apparatus according to the disclosure, the verification device is configured such that the verification device is only converted or convertible to the mounting state if the anchoring or latching area of the anchoring component or latching component is or has been fully inserted into the mounting aperture provided in the carrier component; and/or such that the verification device is only converted or convertible to the mounting state if the anchoring or latching area of the anchoring component or latching component is or has been inserted with a previously-determined or determinable minimum mounting force, in particular in the axial direction of the anchoring or latching area, into the mounting aperture provided in the carrier component; and/or such that the verification device is only converted or convertible to the mounting state if the anchoring or latching area of the anchoring component or latching component is or has been inserted into a mounting aperture adapted, especially in terms of size and/or shape, to the anchoring or latching area of the anchoring or latching component.

In preferred implementations of the fastening apparatus according to the disclosure, the verification device comprises a sliding body, which is at least partially or in regions movably mounted on or in the anchoring or latching area of the anchoring component or latching component relative to the anchoring or latching area of the anchoring component or latching component.

In this context, it is particularly provided that the sliding body of the verification device is movable relative to the anchoring or latching area of the anchoring/latching component between a delivery position and a mounting position of the sliding body, wherein, in the mounting position of the sliding body, at least one indicator of the verification device in or at the holding area of the anchoring/latching component is or becomes optically detectable.

In particular, the sliding body is configured such that, upon insertion of the anchoring or latching area of the anchoring/latching component into the mounting aperture provided in the carrier component, it is only movable into the mounting position if the anchoring or latching area of the anchoring/latching component is or has been fully inserted into the mounting aperture provided in the carrier component; and/or if the anchoring or latching area of the anchoring/latching component is or has been inserted with a previously-determined or determinable minimum mounting force, particularly in the axial direction of the anchoring or latching area, into the mounting aperture provided in the carrier component; and/or if the anchoring or latching area of the anchoring/latching component is or has been inserted into a mounting aperture adapted, especially in terms of size and/or shape, to the anchoring or latching area of the anchoring/latching component.

According to embodiments of the fastening apparatus according to the disclosure, the anchoring/latching component, and in particular the anchoring or latching area of the anchoring/latching component, comprises a receiving area into which the sliding body is at least partially or in regions received, wherein the receiving area is configured to guide the sliding body relative to the anchoring/latching component as it moves.

It is provided that, in the delivery position of the sliding body, the sliding body projects at least partially or in regions from the receiving area of the anchoring/latching component, and that, in the mounting position of the sliding body, the sliding body is further moved into the receiving area of the anchoring/latching component compared to the delivery position.

In preferred implementations of the fastening apparatus according to the disclosure, it is provided that the verification device comprises at least one, preferably at least partially or in regions, elastic and in particular spring elastic arm area, and preferably two opposite, preferably at least partially or in regions, elastic and in particular spring elastic arm areas, which are each connected to the sliding body via a first end area and preferably to an end area of the sliding body facing the holding area of the anchoring/latching component, and which comprise a second end area opposite the first end area.

It is advantageous in this respect that the sliding body and the at least one arm area are configured as a single-piece plastic part, in particular a plastic injection-molded part.

It can further be provided that the at least one arm area is configured such that it applies at least partially a biasing force on the sliding body in the insertion direction of the anchoring or latching area of the anchoring/latching component so that the sliding body is biased in its delivery position.

According to embodiments of the fastening apparatus according to the present disclosure, the holding area of the anchoring/latching component comprises a guide system preferably configured as one piece with the holding area of the anchoring/latching component, in particular in the form of at least one guide groove or at least one guide channel, and wherein the second end area of the at least one arm area is configured as a free end area, which is received at least partially or in regions into the guide system.

It is provided that the verification device is configured such that upon insertion of the anchoring or latching area of the anchoring/latching component into the mounting aperture provided in the carrier component and/or when the fastening apparatus is converted to the mounting state, the sliding body is moved, relative to the anchoring or latching area of the anchoring/latching component, opposite the insertion direction of the anchoring or latching area of the anchoring/latching component, and the second end area of the at least one arm area in the guide system is moved relative to the holding area of the anchoring/latching component.

In this context, it is particularly conceivable that a stopper is associated with the sliding body to limit movement of the sliding body opposite the insertion direction of the anchoring or latching area of the anchoring/latching component.

In preferred implementations of the fastening apparatus according to the disclosure, it is provided that the guide system comprises a window area, through which the second end area of the at least one arm area becomes at least partially or in regions visible if the second end area of the at least one arm area has moved over a previously-determined or determinable distance in the guide system relative to the holding area of the anchoring/latching component.

Alternatively or additionally, it may be provided that the guide system and/or the second end area of the arm area comprises a latch area, with which the second end area of the at least one arm area forms a latch connection if the second end area of the at least one arm area has moved relative to the holding area of the anchoring/latching component over a previously-determined or determinable distance in the guide system.

It is advantageous that the latch area is configured to provide audibly and/or haptically perceptible feedback to the person mounting the fastening apparatus when forming the latch connection to the second end area of the at least one arm area.

According to embodiments of the fastening apparatus according to the disclosure, it is provided that the verification device is configured such that, if the fastening apparatus is converted to the mounting state, the sliding body is firstly moved relative to the anchoring or latching area of the anchoring/latching component opposite the insertion direction of the anchoring or latching area of the anchoring/latching component up to the stop associated with the sliding body and, secondly, the second end area of the at least one arm area is moved by the previously-determined or determinable distance in the guide system relative to the holding area of the anchoring/latching component.

Preferably, the anchoring/latching component with the anchoring or the latching area and the holding area are configured as a single-piece plastic part, in particular a plastic injection-molded part.

It can be provided that one or more wings are formed on the spring elastic arm area, preferably for carrying one or more guide elements. Due to the wings on the spring elastic arm area, the guide elements can be lifted through the spring elastic arm area via a carrying area during the mounting of the fastening apparatus. As a result, the optically detectable indicator is on a plane with the guide elements across the entire carrying area, indicating correct mounting of the anchoring or latching component to the carrier component. Thus, springing back of the fastening apparatus in the carrier component can be compensated, which may be caused, for example, by mounting a heavy cable to the fastening apparatus.

In the following sections, exemplary embodiments of the fastening apparatus according to the disclosure are described in more detail with reference to the accompanying drawings.

The embodiments of the fastening apparatus according to the disclosure shown in the drawings are particularly suitable for connecting cables or cable harnesses to a carrier component, for example to a body component of a vehicle. Particularly in such applications, proper mounting of the fastening apparatus must be visible.

As will be explained in more detail below, in the exemplary embodiments of the fastening apparatus of the disclosure shown in the drawings, a verification device is provided.

By mounting the fastening apparatus in a mounting aperture provided in the carrier component of the vehicle, a bar or button of the verification device is slid upwards, i.e., contrary to the insertion direction of the fastening apparatus, into the mounting aperture, which then verifies the correct installation or mounting by lighting an indicator with a color. Alternatively, however, it is also conceivable that the correct mounting is displayed via a QR code, barcode, or the like using the verification device.

The exemplary embodiments of the fastening apparatus 1 according to the disclosure shown in the drawings are for fastening a component 50 to a carrier component 51 in or on a vehicle.

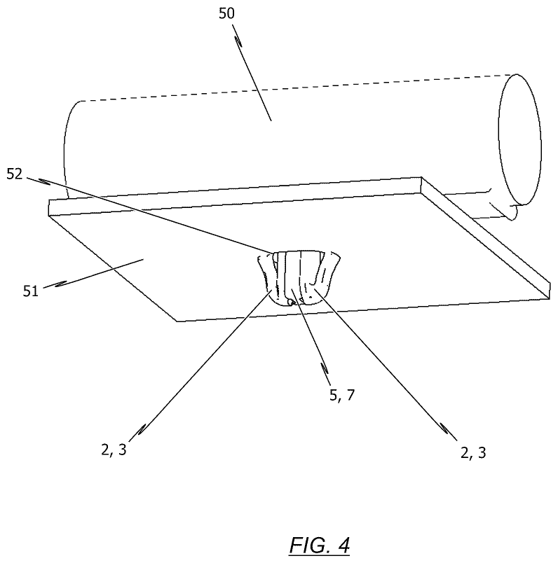

The component 50 to be fastened is—as indicated in FIG. 4 to FIG. 6—a cord-like component having an approximately circular cross-section. In particular, this may be a line, for example, an electrical line or signal line, a cable harness, or a fluid line.

The fastening apparatus 1 is specifically used to provide a mounting capability for a component 50 to be fastened to the carrier component 51 of the vehicle. For this purpose, the fastening apparatus 1 according to the embodiments shown in the drawings comprises an anchoring/latching component 2. The anchoring/latching component 2 is in particular a single-piece plastic component, in particular a plastic injection-molded component.

The anchoring/latching component 2 comprises an anchoring/latching area 3 and has a holding area 4 connected to the anchoring or latching area 3. The anchor or latching area 3 serves to be mounted on the carrier component 51 or to be mounted in a mounting aperture 52 of the carrier component 51. For this purpose, the anchoring or latching area 3 of the fastening apparatus 1 is inserted into the mounting aperture 52 of the carrier component 51.

The anchoring or latching area 3 preferably comprises rib-shaped projections, which can in particular be designed to be spring elastic in order to provide a form-fitting and/or frictional connection of the anchoring or latching area 3 in the mounting aperture 52 provided in the carrier component 51.

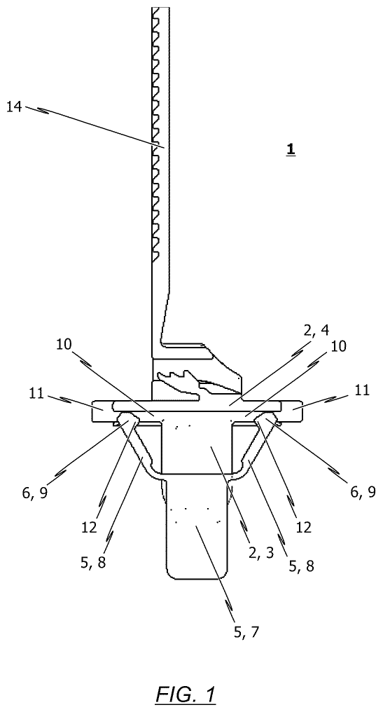

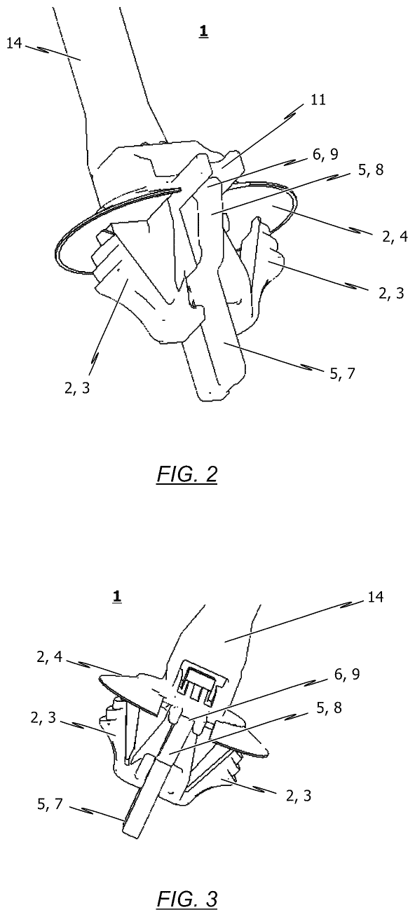

The holding area 4 of the anchoring/latching component 2 is configured as a relatively flat plane. This holding area 4 serves to receive the component 50 to be fastened accordingly. This may be done, for example, with the aid of a cable tie 14, the lock region of which may be configured as one piece with the holding area 4 of the anchoring/latching component 2, as indicated in FIG. 1 to FIG. 3.

However, the disclosure is not limited to embodiments in which the component 50 to be fastened is connected to the holding area 4 of the anchoring/latching component 2 via a cable tie 14 or the like.

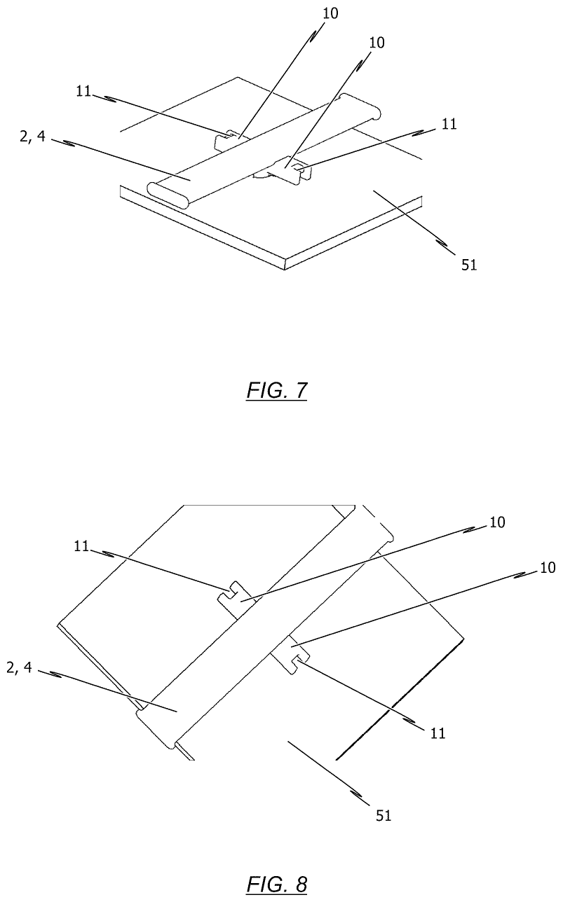

For example, as shown in FIG. 4 through FIG. 8, the holding area 4 of the anchoring/latching component 2 serves as a suitable platform for fastening the component 50 to be fastened.

The exemplary embodiments of the fastening apparatus 1 according to the disclosure are further equipped with a corresponding verification device 5. The verification device 5 is configured to confirm correct mounting of the anchoring/latching component 2 on the carrier component 51 in or at the holding area 4 of the anchoring/latching component 2, in particular via at least one optically detectable indicator 6.

Importantly, the optically detectable indicator 6 of the verification device 5 appears in or on the head region of the fastening apparatus 1 to confirm the correct mounting of the anchoring/latching component 2 on the carrier component 51. In this way, proper installation or mounting of the fastening apparatus 1 in the mounting aperture 52 of the carrier component 51 is immediately apparent, even in areas of the vehicle that are difficult to access.

The anchoring or latching area 3 of the anchoring/latching component 2 is at least partially or in regions designed as a plug-in part and configured to be inserted into a mounting aperture 52 provided in the carrier component 51 for mounting of the fastening apparatus 1 on the carrier component 51 and to form a particularly frictional and/or form-fitting connection with the carrier component 51.

It is generally conceivable that the fastening apparatus 1, and in particular the anchoring or latching area 3 of the anchoring/latching component 2, is configured such that the fastening apparatus 1 is also reversibly removable.

The verification device 5 of the exemplary embodiments of the fastening apparatus 1 according to the disclosure shown in the drawings is configured such that, upon insertion of the anchoring or latching area 3 of the anchoring/latching component 2 into the mounting aperture 52 provided in the carrier component 51, the verification device 5 is converted or convertible from a delivery state to a mounting state. In the mounting state of the verification device 5, at least one indicator 6 of the verification device 5 is optically detectable in or at the holding area 4 of the anchoring/latching component 2.

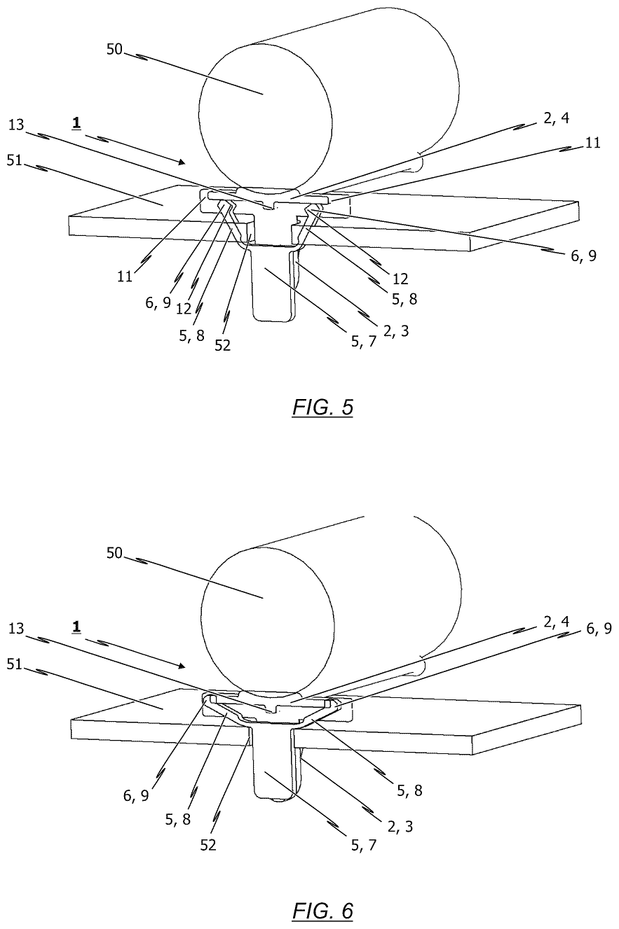

In FIG. 1 and FIG. 5, the respective verification device 5 is shown respectively in its delivery state, while in particular FIG. 6 shows the verification device 5 in its mounting state.

The verification device 5 is configured such that it is only converted or convertible to the mounting state if the anchoring or latching area 3 of the anchoring/latching component 2 has been fully inserted into the mounting aperture 52 provided in the carrier component 51. Preferably, the verification device 5 is only converted or convertible to the mounting state if the anchoring or latching area 3 of the anchoring/latching component 2 has been inserted with a previously-determined or determinable minimum mounting force, in particular in the axial direction of the anchoring or latching area 3, into the mounting aperture 52 provided in the carrier component 51.

Although not shown in the drawings, it is further conceivable that the verification device 5 is only converted or convertible to the mounting state if the anchoring or latching area 3 of the anchoring/latching component 2 is or has been inserted into a mounting aperture 52 adapted, especially in terms of size and/or shape, to the anchoring or latching area 3 of the anchoring/latching component 2.

The two exemplary embodiments of the fastening apparatus 1 according to the disclosure shown in the drawings have in common that the verification device 5 used each comprises a sliding body 7, which is at least partially or in regions movably mounted on or in the anchoring or latching area 3 of the anchoring/latching component 2 relative to the anchoring/latching region 3 of the anchoring/latching component 2.

In this respect, the sliding body 7 of the verification device 5 is movable relative to the anchoring or latching area 3 of the anchoring/latching component 2 between a delivery position and a mounting position. In the mounting position of the sliding body, at least one indicator 6 of the verification device 5 is optically detectable in or at the holding area 4 of the anchoring/latching component 2, or at least one indicator 6 of the verification device 5 becomes optically detectable in or at the holding area 4 of the anchoring/latching component 2.

In the embodiments shown in the drawings of the fastening apparatus 1 according to the disclosure, the sliding body 7 is configured such that, upon insertion of the anchoring or latching area 3 of the anchoring/latching component 2 into the mounting aperture 52 provided in the carrier component 51, the sliding body can only be moved into the mounting position if the anchoring or latching area 3 of the anchoring/latching component 2 is or has been fully inserted into the mounting aperture 52 provided in the carrier component 51, and if the anchoring or latching area 3 of the anchoring/latching component 2 is or has been inserted with a previously-determined or determinable minimum mounting force, especially in the axial direction of the anchoring or latching area 3, into the mounting aperture 52 provided in the carrier component 51.

In addition, it is also conceivable that the sliding body 7 is designed such that, upon insertion of the anchoring or latching area 3 of the anchoring/latching component 2 into the mounting aperture 52 provided in the carrier component 51, the sliding body can only be moved into the mounting position if the anchoring or latching area 3 of the anchoring/latching component 2 is or has been inserted into a mounting aperture 52 adapted, especially in terms of size and/or shape, to the anchoring or latching area 3 of the anchoring/latching component 2.

With regard to the verification device 5 of the exemplary embodiments of the fastening apparatus 1 according to the disclosure shown in the drawings, it is particularly provided that the anchoring/latching component 2, and in particular the anchoring or latching area 3 of the anchoring/latching component 2, comprises a receiving area into which the sliding body 7 is at least partially or in regions received, wherein the receiving area is configured to guide the sliding body 7 relative to the anchoring/latching component 2 as it moves.

It is provided that, in the delivery position of the sliding body 7, the sliding body 7 projects at least partially or in regions from the receiving area of the anchoring/latching component 2, and that, in the mounting position of the sliding body 7, the sliding body 7 is further moved into the receiving area of the anchoring/latching component 2 compared to the delivery position.

As can in particular be seen from the illustrations in FIG. 5 and FIG. 6, the verification device 5 comprises two opposite, preferably at least partially or in regions, elastic and in particular spring elastic arm areas 8, which are each connected to the sliding body 7 via a first end area and preferably to an end area of the sliding body 7 facing the holding area 4 of the anchoring/latching component 2, and which comprise a second (free) end area 9 opposite the first end area.

It is provided that the sliding body 7 and the two arm areas 8 are configured as a single-piece plastic part, in particular as a plastic injection-molded part.

It is further provided that the arm areas 8 are configured such that they at least partially apply a biasing force to the sliding body 7 in the insertion direction of the anchoring or latching area 3 of the anchoring/latching component 2.

The illustrations in FIG. 5 and FIG. 6 may further indicate that the holding area 4 of the anchoring/latching component 2 comprises a guide system 10, preferably configured as one piece with the holding area 4 of the anchoring/latching component 2, particularly in the form of at least one guide groove or at least one guide channel.

The respective second end areas 9 of the two arm areas 8 are each configured as a free end area, which is at least partially or in regions received in the guide system 10.

The verification device 5 is configured such that, upon insertion of the anchoring or latching area 3 of the anchoring/latching component 2 into the mounting aperture 52 provided in the carrier component 51 and/or when the fastening apparatus 1 is converted to the mounting state, the sliding body 7 is firstly moved, relative to the anchoring or latching area 3 of the anchoring/latching component 2, opposite the insertion direction of the anchoring or latching area 3 of the anchoring/latching component 2, and secondly, the second (free) end areas 9 of the two arm areas 8 in the guide system 10 are moved relative to the holding area 4 of the anchoring/latching component 2.

As is further shown in FIG. 5 and FIG. 6, a stop 13 is associated with the sliding body 7 for limiting movement of the sliding body 7 contrary to the insertion direction of the anchoring and latching area 3 of the anchoring/latching component 2.

As can be seen in particular in FIG. 1, FIG. 5 and FIG. 6, the guide system 10 comprises a window area 11 through which each second end area 9 of the two arm areas 8 become, at least partially or in regions, visible if the second end areas 9 of the two arm areas 8 have moved over a previously-determined or determinable distance in the guide system 10 relative to the holding area 4 of the anchoring/latching component 2.

Furthermore, it is provided that the guide system 10, together with the second end area 9 of the arm area 8, comprises a latch area 12, with which a latch connection is formed if the second end area 9 of the corresponding arm area 8 has moved over a previously-determined or determinable distance in the guide system 10 relative to the holding area 4 of the anchoring/latching component 2.

It is conceivable in this context that the latch area 12 is configured to provide audibly and/or haptically perceptible feedback to the person mounting the fastening apparatus 1 when forming the latch connection to the second end area of the at least one arm area 8.

In principle, the verification device 5 is configured such that, if the fastening apparatus 1 is converted to the mounting state, the sliding body 7 is firstly moved relative to the anchoring or latching area 3 of the anchoring/latching component 2 opposite the insertion direction of the anchoring or latching area 3 of the anchoring/latching component 2 up to the stop 13 associated with the sliding body 7 and, secondly, the second end area 9 of the at least one arm area 8 is moved by the previously-determined or determinable distance in the guide system 10 relative to the holding area 4 of the anchoring/latching component 2.

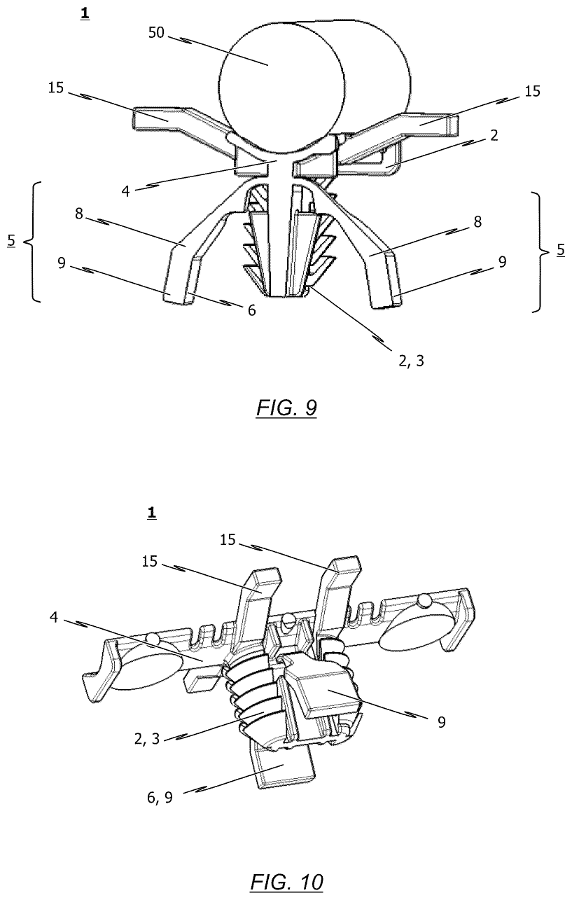

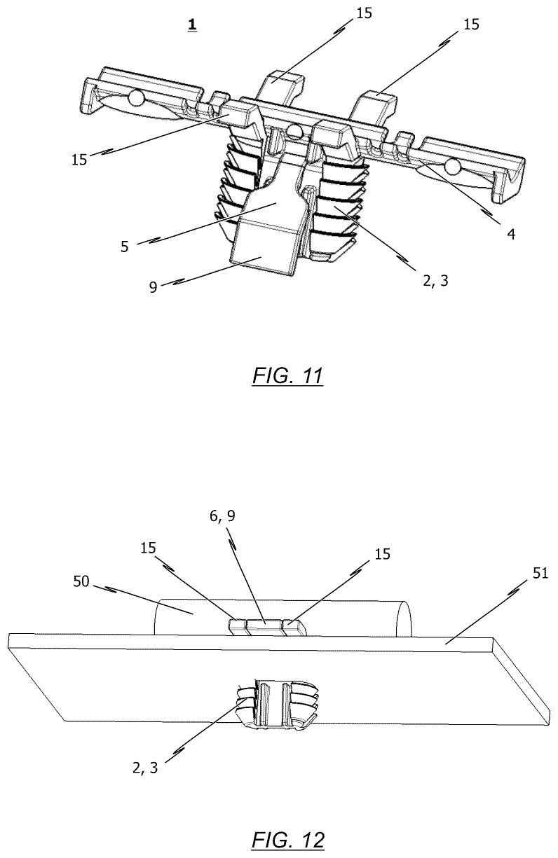

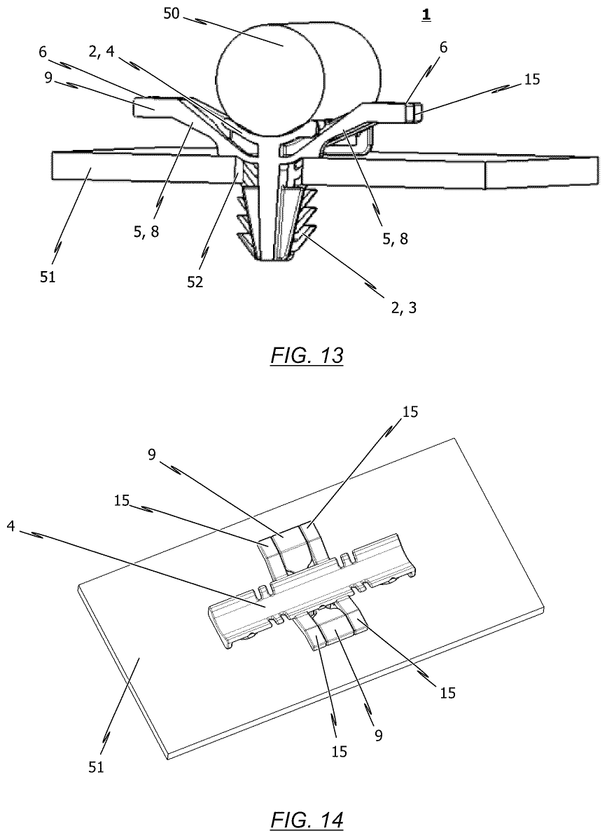

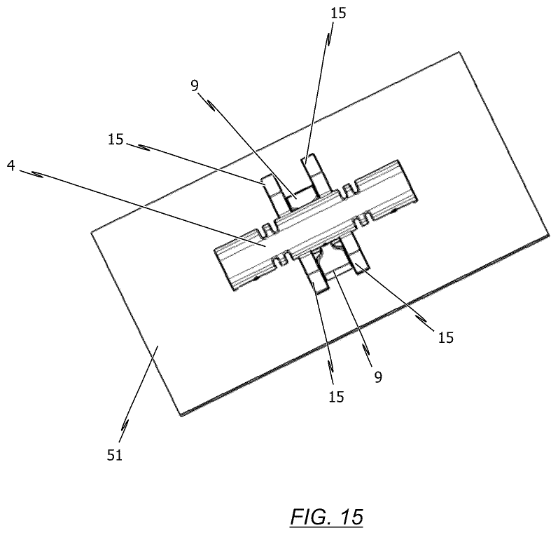

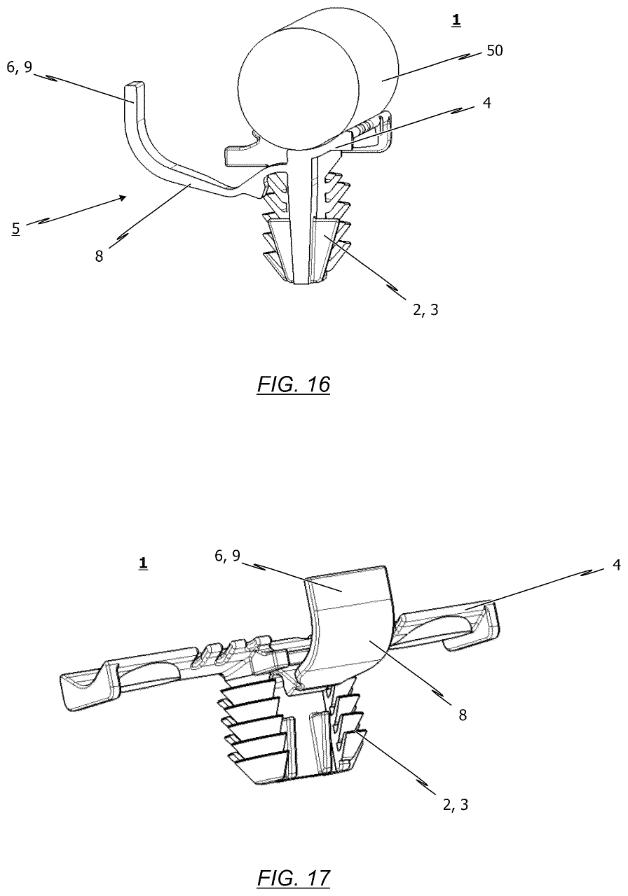

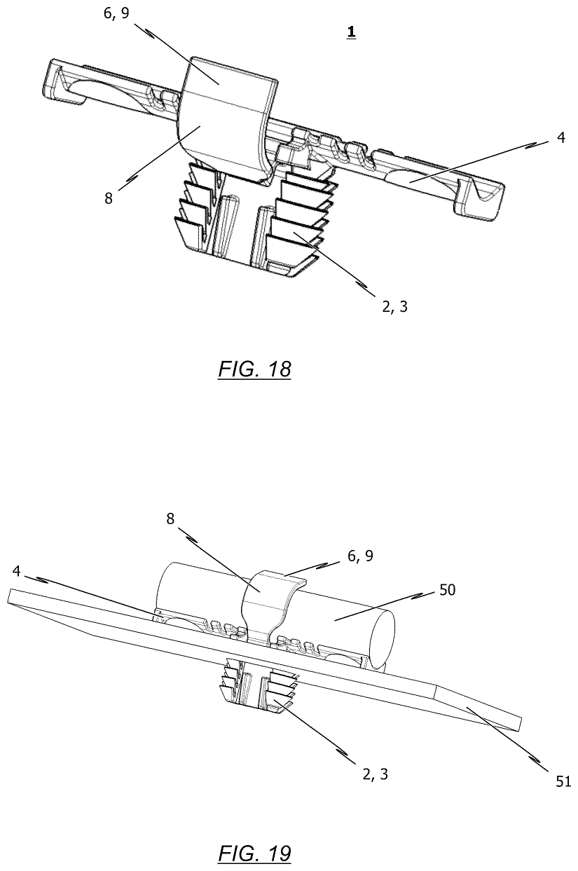

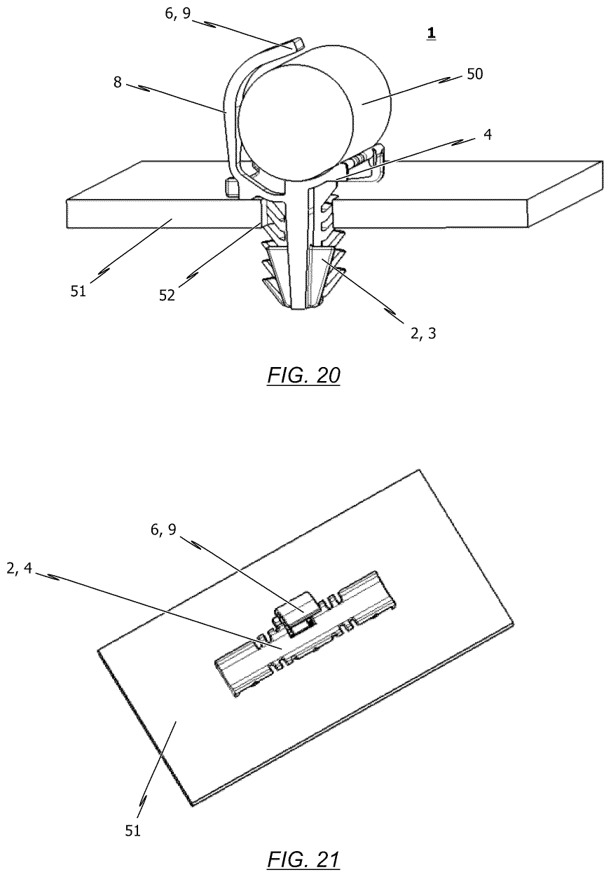

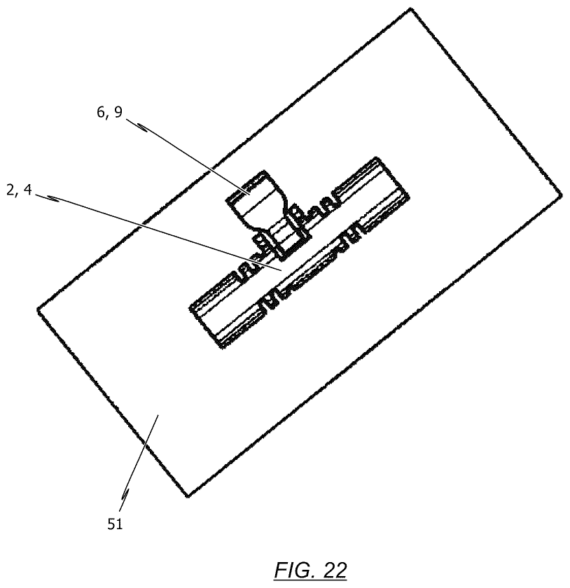

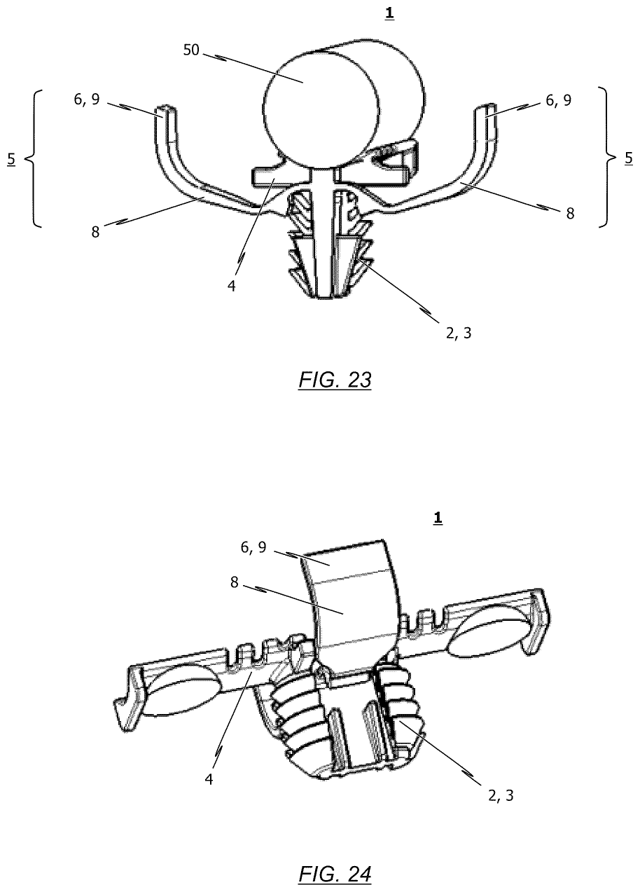

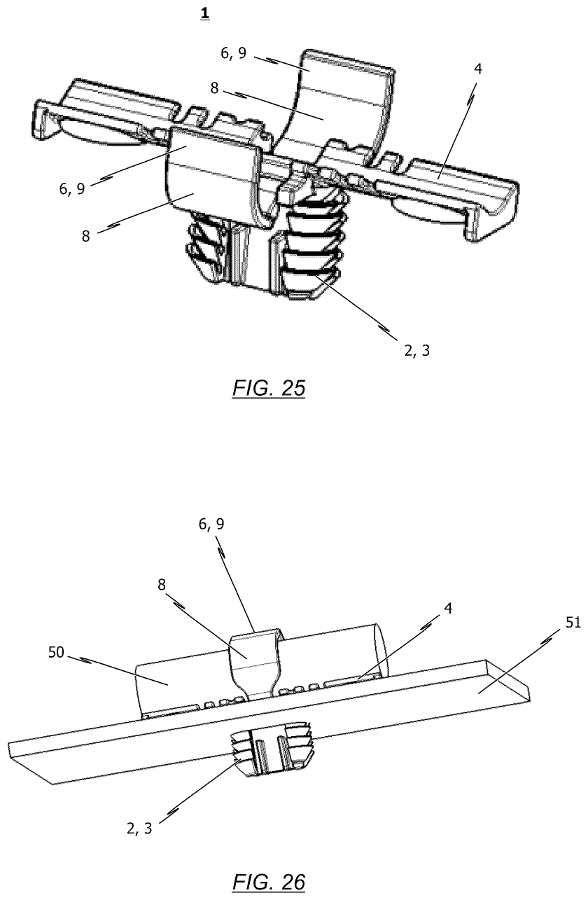

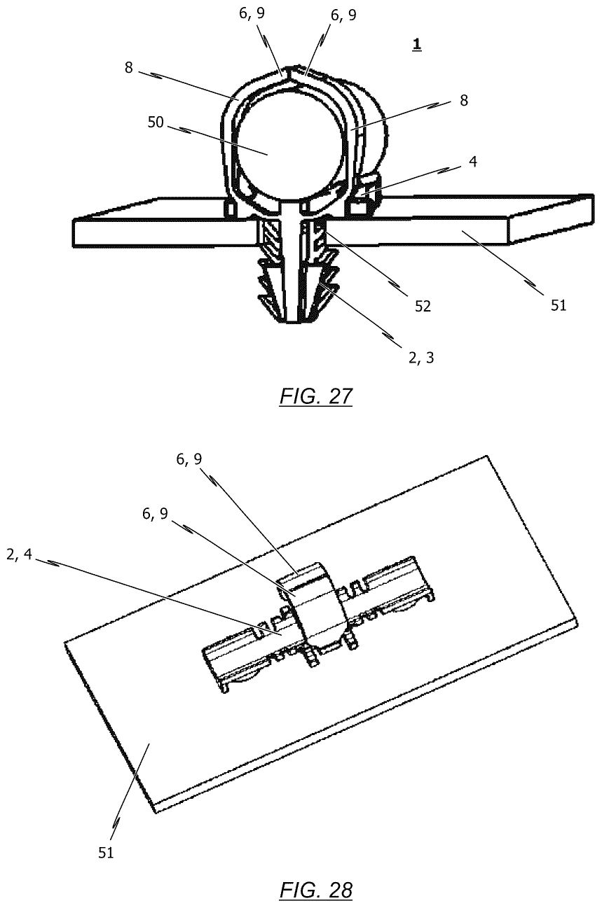

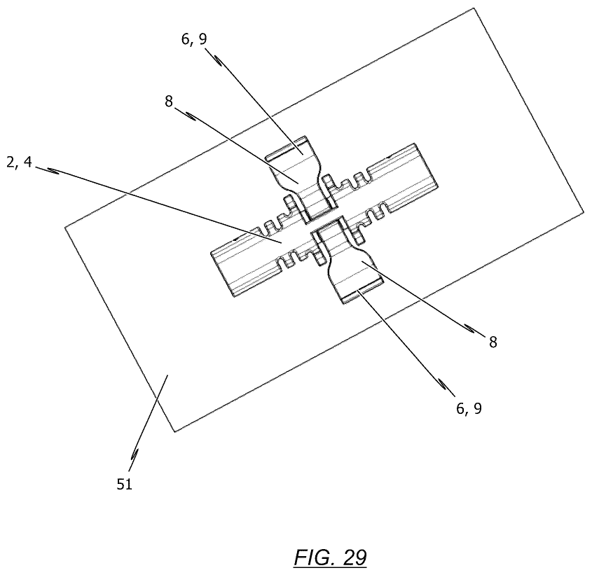

The embodiments of the fastening apparatus 1 according to the disclosure shown in FIG. 9 to FIG. 29 substantially correspond to the embodiments described above, although the third to fifth exemplary embodiments of the fastening apparatus 1 according to the disclosure are in particular characterized by the overall fastening apparatus 1 being configured as a single-piece component. Conversely, the embodiments of the fastening apparatus 1 according to FIG. 1 through FIG. 8 are configured as a two-piece concept.

Of course, from a functional perspective, the third to sixth exemplary embodiments correspond to the previously described embodiments of FIG. 1 through FIG. 8.

In the third exemplary embodiment of the fastening apparatus 1 according to the disclosure, the verification device 5 still comprises guide elements 15 associated with the arm area 8 that guide the pivoting of the arm areas 8.

The disclosure is not limited to the embodiments shown in the drawings, but results when all of the features disclosed herein are considered together.

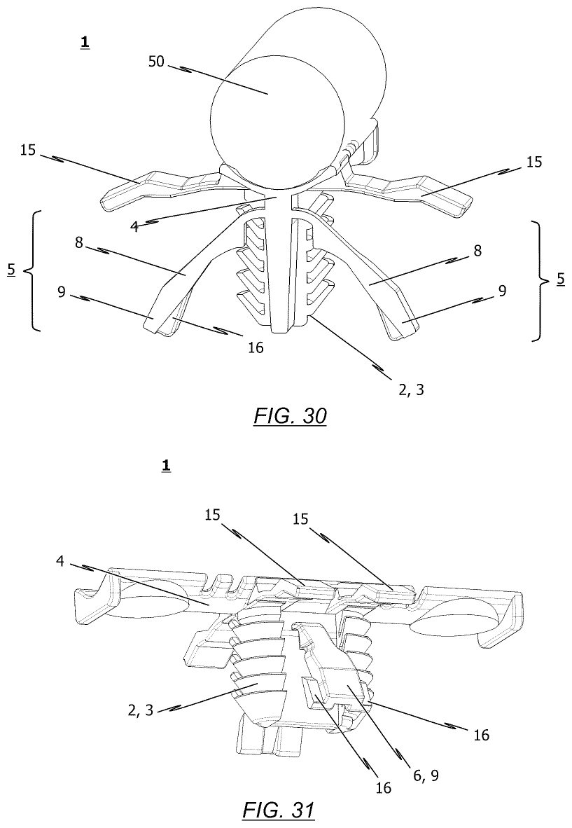

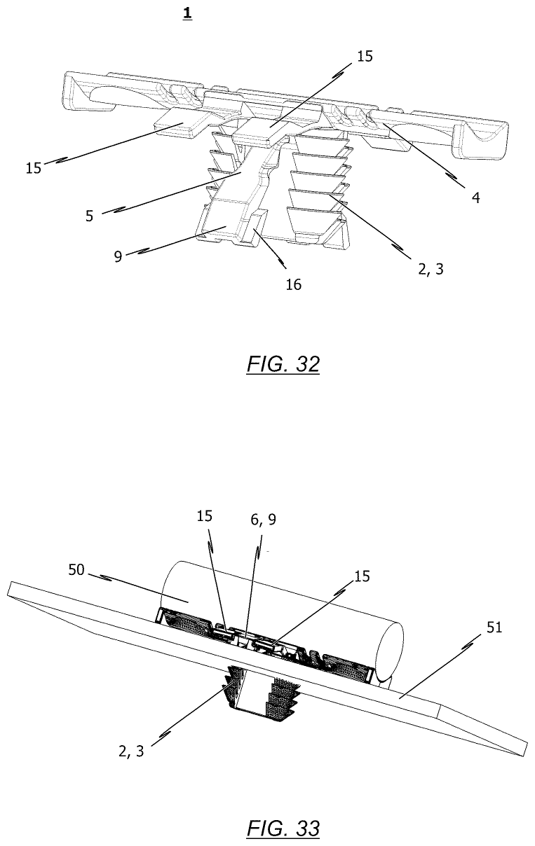

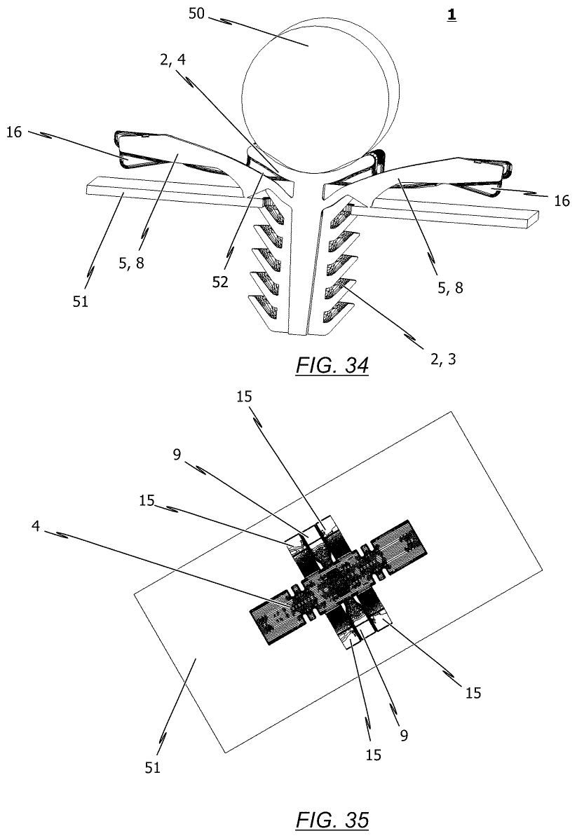

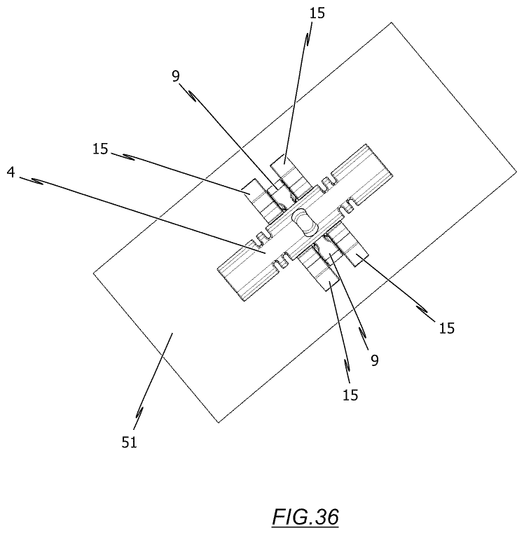

In the sixth exemplary embodiment of the fastening apparatus 1 according to the disclosure, shown in FIGS. 30-36, the verification device 5 on the spring elastic arm area 8 comprises one or more wings 16 (see FIGS. 30-32) configured to carry one or more guide elements 15. Due to the wings 16 on the spring elastic arm area 8, the guide elements 15 can be lifted through the spring elastic arm area 8 via a carrying area during the mounting of the fastening apparatus 1. As a result, the optically detectable indicator 6 is on a plane with the guide elements 15 (see FIGS. 33, 34, and 35) across the entire carrying area, indicating correct mounting of the anchoring or latching component 2, 3 to the carrier component 51. Thus, springing back of the fastening apparatus 1 in the carrier component 51 can be compensated, which may be caused, for example, by mounting a heavy cable to the fastening apparatus 1.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Fastening apparatus
2 Anchoring/latching component
3 Anchoring or latching area of the anchoring/latching component
4 Holding area of the anchoring/latching component
5 Verification device
6 Indicator
7 Sliding body of the verification device
8 Arm area of the verification device
9 Second (free) end area of the arm area of the verification device
10 Guide system
11 Window area of the guide system
12 Latch area of the guide system
13 Stop
14 Cable ties
15 Guide element
16 Wings
50 Component to be attached
51 Carrier component
52 Mounting aperture in the carrier component

What is claimed is:

1. A fastening apparatus (1) for fastening a component (50) to a carrier component (51) in or on a vehicle, wherein the fastening apparatus (1) comprises:
an anchoring component or a latching component (2) with an anchoring or latching area (3), which is configured for mounting on the carrier component (51), and a holding area (4) opposite the anchoring or latching area (3), to which the component (50) to be attached to the carrier component (51) is connected or connectable; and
a verification device (5), which is configured to confirm correct mounting of the anchoring or latching component (2) on the carrier component (51) in or at the holding area (4) of the anchoring component or latching component (2) via at least one optically detectable indicator (6).

2. The fastening apparatus (1) according to claim 1,
wherein the anchoring or latching area (3) of the anchoring or latching component (2) is at least partially or in regions designed as a plug-in part and configured to be inserted into a mounting aperture (52) provided in the carrier component (51) for mounting of the fastening apparatus (1) on the carrier component (51) and to form a particularly frictional and/or form-fitting connection with the carrier component (51).

3. The fastening apparatus (1) according to claim 2,
wherein the verification device (5) is configured such that, upon insertion of the anchoring or latching area (3) of the anchoring or latching component (2) into the mounting aperture (52) provided in the carrier component (51), the verification device (5) is converted or convertible from an initial delivery state to a mounting state, wherein, in the mounting state of the verification device (5), at least one indicator (6) of the verification device (5) is or becomes optically detectable in or at the holding area (4) of the anchoring or latching component (2).

4. The fastening apparatus (1) according to claim 3,
wherein the verification device (5) is configured:
such that the verification device (5) is only converted or convertible to the mounting state if the anchoring or latching area (3) of the anchoring or latching component (2) is or has been fully inserted into the mounting aperture (52) provided in the carrier component (51); and/or
such that the verification device (5) is only converted or convertible to the mounting state if the anchoring or latching area (3) of the anchoring or latching component (2) is or has been inserted with a previously-determined or determinable minimum mounting force into the mounting aperture (52) provided in the carrier component (51); and/or
such that the verification device (5) is only converted or convertible to the mounting state if the anchoring or latching area (3) of the anchoring or latching component (2) is or has been inserted into a mounting aperture (52) adapted, especially in terms of size and/or shape, to the anchoring or latching area (3) of the anchoring or latching component (2).

5. The fastening apparatus (1) according to claim 1,
wherein the verification device (5) comprises a sliding body (7), which is at least partially or in regions movably mounted on or in the anchoring or latching area (3) of the anchoring or latching component (2) relative to the anchoring or latching area (3) of the anchoring or latching component (2).

6. The fastening apparatus (1) according to claim 5,
wherein the sliding body (7) of the verification device (5) is movable relative to the anchoring or latching area (3) of the anchoring or latching component (2) between a delivery position and a mounting position, wherein, in the mounting position of the sliding body (7), at least one indicator (6) of the verification device (5) in or at the holding area (4) of the anchoring or latching component (2) is or becomes optically detectable.

7. The fastening apparatus (1) according to claim 5,
wherein the sliding body (7) is configured such that, upon insertion of the anchoring or latching area (3) of the anchoring or latching component (2) into the mounting aperture (52) provided in the carrier component (51), it is only movable into the mounting position,
if the anchoring or latching area (3) of the anchoring or latching component (2) is or has been fully inserted into the mounting aperture (52) provided in the carrier component (51); and/or
if the anchoring or latching area (3) of the anchoring or latching component (2) is or has been inserted with a previously-determined or determinable minimum mounting force into the mounting aperture (52) provided in the carrier component (51); and/or
if the anchoring or latching area (3) of the anchoring or latching component (2) is or has been inserted into a mounting aperture (52) adapted, especially in terms of size and/or shape, to the anchoring or latching area (3) of the anchoring or latching component (2).

8. The fastening apparatus (1) according to claim 5,
wherein the anchoring or latching component (2) comprises a receiving area into which the sliding body (7) is at least partially or in regions received, and wherein the receiving area is configured to guide the sliding body (7) relative to the anchoring or latching component (2) as it moves.

9. The fastening apparatus (1) according to claim 8,
wherein, in the delivery position of the sliding body (7), the sliding body (7) projects at least partially or in regions from the receiving area of the anchoring or latching component (2), and wherein, in the mounting position of the sliding body (7), the sliding body (7) is further moved into the receiving area of the anchoring or latching component (2) compared to the delivery position.

10. The fastening apparatus (1) according to claim 5,
wherein the verification device (5) comprises at least one spring elastic arm area (8), which are each connected to the sliding body (7) via a first end area and to an end area of the sliding body (7) facing the holding area (4) of the anchoring or latching component (2) and which comprise a second end area (9) opposite the first end area.

11. The fastening apparatus (1) according to claim 10,
wherein the sliding body (7) and the at least one arm area (8) are configured as a single-piece plastic part.

12. The fastening apparatus (1) according to claim 10,
wherein the at least one arm area (8) is configured such that it at least partially applies a biasing force to the sliding body (7) in the insertion direction of the anchoring or latching area (3) of the anchoring or latching component (2).

13. The fastening apparatus (1) according to claim 10,
wherein the holding area (4) of the anchoring or latching component (2) comprises a guide system (10) configured as one piece with the holding area (4) of the anchoring or latching component (2), and wherein the second end area (9) of the at least one arm area (8) is configured as a free end area, which is received at least partially or in regions into the guide system (10).

14. The fastening apparatus (1) according to claim 13,
wherein the verification device (5) is configured such that upon insertion of the anchoring or latching area (3) of the anchoring or latching component (2) into the mounting aperture (52) provided in the carrier component (51) and/or when the fastening apparatus (1) is converted to the mounting state, the sliding body (7) is moved, relative to the anchoring or latching area (3) of the anchoring or latching component (2), opposite the insertion direction of the anchoring or latching area (3) of the anchoring or latching component (2), and the second end area (9) of the at least one arm area (8) in the guide system (10) is moved relative to the holding area (4) of the anchoring or latching component (2).

15. The fastening apparatus (1) according to claim 14,
wherein a stop (13) is associated with the sliding body (7) for limiting a movement of the sliding body (7) contrary to the insertion direction of the anchoring or latching area (3) of the anchoring or latching component (2).

16. The fastening apparatus (1) according to claim 14,
wherein the guide system (10) comprises a window area (11), through which the second end area (9) of the at least one arm area (8) becomes at least partially or in regions visible if the second end area (9) of the at least one arm area (8) has moved over a previously-determined or determinable distance in the guide system (10) relative to the holding area (4) of the anchoring or latching component (2).

17. The fastening apparatus (1) according to claim 14,
wherein the guide system (10) comprises a latch area (12), with which the second end area (9) of the at least one arm area (8) forms a latch connection if the second end area (9) of the at least one arm area (8) has moved over a previously-determined or determinable distance in the guide system (10) relative to the holding area (4) of the anchoring or latching component (2).

18. The fastening apparatus (1) according to claim 17,
wherein the latch area (12) is configured to provide audibly and/or haptically perceptible feedback to the person mounting the fastening apparatus (1) when forming the latch connection to the second end area of the at least one arm area (8).

19. The fastening apparatus (1) according to claim 15,
wherein the verification device (5) is configured such that, if the fastening apparatus (1) is converted to the mounting state, the sliding body (7) is firstly moved relative to the anchoring or latching area (3) of the anchoring or latching component (2) opposite the insertion direction of the anchoring or latching area (3) of the anchoring or latching component (2) up to the stop (13) associated with the sliding body (7) and, secondly, the second end area (9) of the at least one arm area (8) is moved by the previously-determined or determinable distance in the guide system (10) relative to the holding area (4) of the anchoring or latching component (2).

20. The fastening apparatus (1) according to claim 5,
wherein the anchoring or latching component (2) with the anchoring or latching area (3) and the holding area (4) are configured as a single-piece plastic part.
